(19) United States
(12) Patent Application Publication
(10) Pub. No.: US 2014/0362561 A1
(43) Pub. Date: Dec. 11, 2014

(54) SURGICAL EYE WEAR AND LIGHT COMBINATION

(71) Applicant: David Neal Faircloth, Martinez, GA (US)

(72) Inventor: David Neal Faircloth, Martinez, GA (US)

(21) Appl. No.: 13/911,495

(22) Filed: Jun. 6, 2013

(51) Int. Cl. G02C 11/04

(52) U.S. Cl. CPC G02C 11/04
USPC 362/103

(57) ABSTRACT

A surgical eye wear and light combination (10) is disclosed having a frame (11), a lens (12, and a light assembly (13). The eye wear frame also includes a pair of oppositely disposed temple arms (18) and a flexible head band (21) extending between the temple arms. The Light assembly includes a light housing (23), a battery pack (24), and an insulated conductor (25). The light housing has a main body portion (27) and a headlamp (28). The battery pack includes a battery pack housing (37) and at least one battery (38) therein. In use, the weight of the battery is separated from the weight of the majority of the eye wear and light housing. Also, if the wearer tilts his or her head downwardly the weight of the heavier battery simply pushes against the back of the wearer's head.

### TECHNICAL FIELD

This invention relates to lights, and more specifically to lights used in combination with surgical eye wear.

### BACKGROUND OF THE INVENTION

Surgical eye wear, such as surgical goggles or surgical glasses, have existed for many years. Typically, a doctor dons the surgical eve wear when examining or performing a procedure upon a patient.

To improve the viewing field for a doctor, surgical lights have been utilized to illuminate the subject area on a patient. These surgical lights are mounted above a patient and provides a wide field of illumination.

Recently, lights have been incorporated into head mounted gear to provide a small light source that can project a concentrated area of light. This type of head mounted light typically includes a light bulb, battery pack and surrounding housing. Some of these types of head mounted lights are incorporated into bulky helmet type devices, such as that shown in U.S. Pat. Nos. 7,192,151 and 8,348,448. These devices are heavy and cumbersome to use. As such, smaller lights have been incorporated into eye wear in the form of glasses. However, these devices typically have all the components in the front of the glasses, thereby making them uncomfortable to wear and front heavy which renders them susceptible to falling when the head is directed downwardly. Surgical glasses having lights have recently been developed wherein the battery is moved to the ends of the pivoting temple arms that are positioned over the wearer's ears, such as that shown in U.S. Patent Application Publication Number 2012/0120636 A1. However, as the weight of the entire device, including the battery, still rests on the wearer's bridge of the nose and ears, these devices are still uncomfortable to wear for an extended period of time. Furthermore, there is nothing that prevents the weight of the device form falling off the wearer's head.

Accordingly, it is seen that a need remains for eye wear that includes a light that is well balanced, not too heavy for the wearer to don for an extended period of time, and designed to restrict the glasses from falling if the head is directed downwardly. It is to the provision of such therefore that the present invention is primarily directed.

### SUMMARY OF THE INVENTION

In a preferred form of the invention a surgical eye wear and light combination comprises an eve wear frame having a front portion and a pair of oppositely disposed temple arms extending from the front portion and terminating at distal ends, a lens coupled to the eye wear frame, a headband coupled to and extending between the temple arm distal ends, a light housing including a light source, the light housing coupled to the eye wear frame, a battery pack coupled to the headband, the battery pack including a battery housing and at least one battery, and an electric conductor extending between the light housing and the battery pack and electrically coupled to the light source and the battery. With this construction, the position of battery pack upon the headband causes the battery pack to rest against the back of a wearer's head when the head is tilted forwardly and downwardly.

### BRIEF DESCRIPTION OF THE DRAWING

FIG. 1 is a perspective view of a surgical eye wear and light combination embodying principles of the invention in a preferred form.

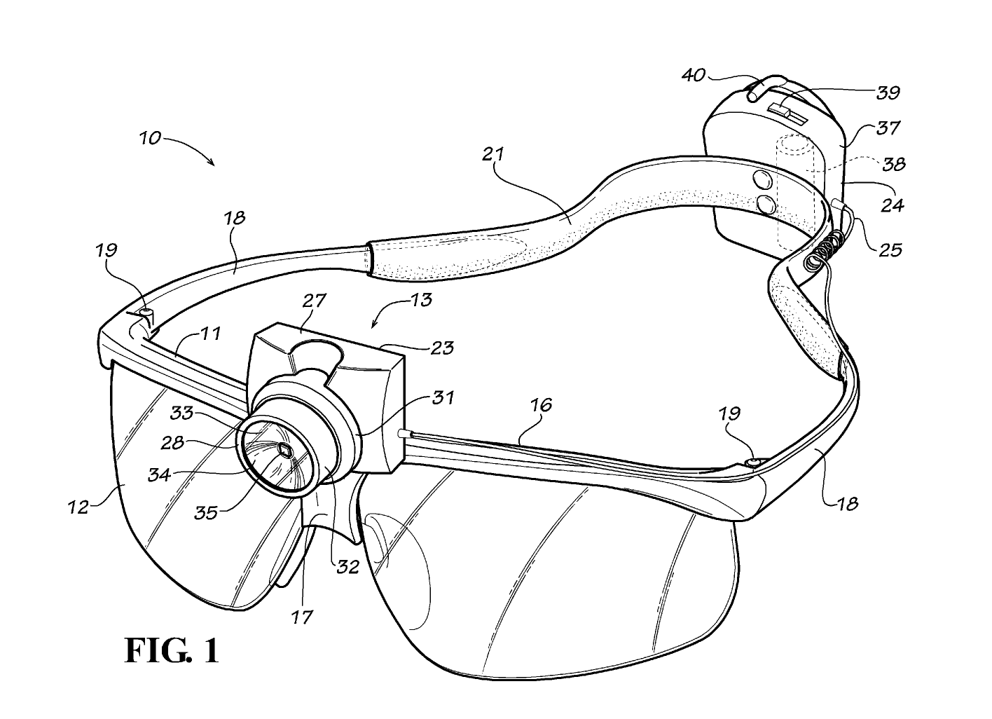

FIG. 2 is a side view of the surgical eye wear and light combination of FIG. 1 shown mounted to a person's head.

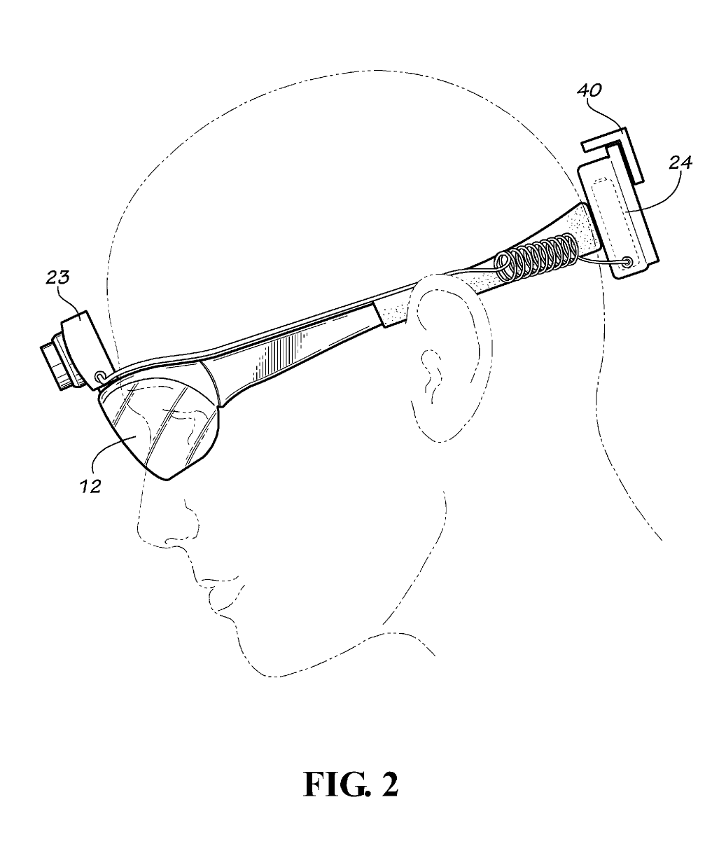

FIG. 3 is a perspective view of a portion of the surgical eye wear and light combination of FIG. 1.

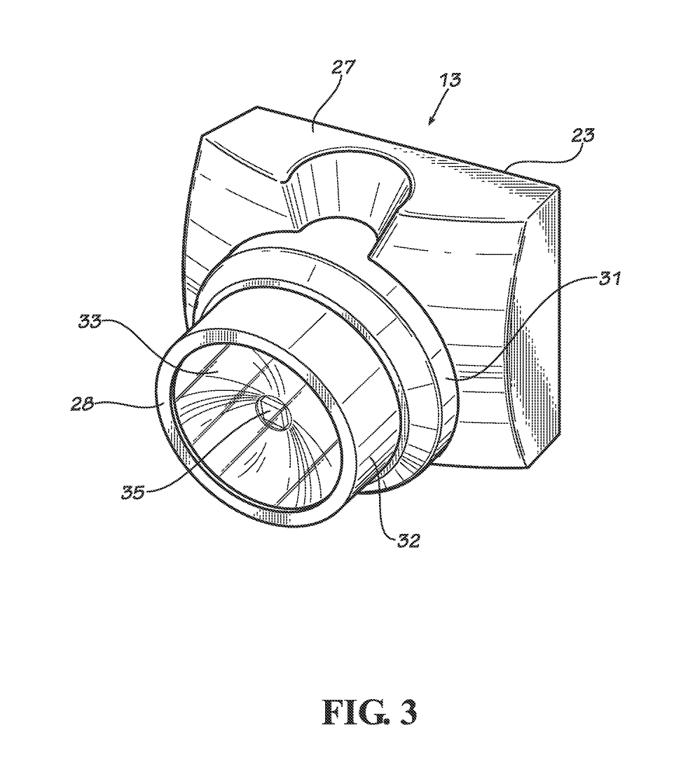

### DETAILED DESCRIPTION

With reference next to the drawings, there is shown a surgical eye wear and light combination, which may be referred to hereinafter as eye wear 10, in a preferred form of the invention. The eye wear 10 includes frame 11, a lens 12, and a light assembly 13 coupled to the frame 11.

The eye wear frame 11 includes a front portion 16 to which the lens 12 is mounted and which includes a central nose bridge 17. The eye wear frame 11 also includes a pair of oppositely disposed temple arms 18 pivotally coupled to the front portion 16 through a pair of hinges 19, and a flexible head band 21 extending between the distal ends of the temple arms 18 opposite the front portion 16. The frame and lens may be made of a molded plastic material or the like suitable for these purposes. The head band 21 may be made of a fabric material, neoprene material, flexible plastic material, or the like.

The light assembly 13 includes a light housing 23, a battery pack 24, and an insulated electrical conductor 25 extending between and electrically coupling the battery pack 24 and light housing 23. The light housing 23 is pivotally coupled to the nose bridge 17 of the frame to vary the angle therebetween in order to adjust the direction of the light beam. The light housing 23 has a main body portion 27 and a headlamp 28. The headlamp 28 has a generally cylindrical outer housing 31, a generally cylindrical inner housing 32 telescopically mounted within the outer housing 33 and having a reflector 33, a lens 34, and a light source 35 which preferably is in the form of a light emitting diode (LED). The inner housing 32 is moveable with respect to the outer housing 31 the vary the distance between the lens 34 and light source 35 to vary the focus of the light beam, and thereby intensity and/or beam width, produced by the light assembly 13. It should be understood that the beam may also be varied by varying the distance between the light source 35 and the reflector 33, as conventionally known in the art.

The battery pack 24 includes a battery pack housing 37 which houses or contains at least one battery 38 Therein. The battery pack 24 also includes an on/off switch 39 for energizing and de-energizing the headlamp 28 with current from the battery 38, and a variable dimmer switch 40 which also controls the intensity of the headlamp 28. The dimmer switch 40 may vary the intensity by varying the current to the headlamp in any conventionally known manner. It should be understood that the electrical conductor 25 couples the battery 38 with the light source 35, and that the batteries may be disposable or rechargeable.

In use a person wears the surgical eye wear and light combination 10 in the typical manner one wears eyeglasses with the headband 28 extending behind the wearer's head. The on/off switch 39 is moved to its “on” position to energize the headlamp 28 and the dimmer switch 40 is moved to a position to provide the desired light intensity. The headlamp inner housing 32 may also be rotated relative to the outer housing 31 to focus the beam of light to the desired beam width and intensity.

With the surgical eye wear and light combination 10 donned upon the wearer's head the weight of the battery pack 24 is separated from the weight of the frame 11, lens and light housing 23. This distribution of the heaviest components tends to balance the weight of the eye wear and light, combination between the front and back of the wearer's head. It should also be noted that if the wearer tilts his or her head downwardly the weight of the heavier battery simply pushes against the back of the wearer's head, rather than causing the eye wear to slip off the wearer's head, which may occur when a majority of the weight is positioned on the front of the wearer's head wherein nothing prevents the eye wear from slipping completely off the head. This aid in preventing the eye wear from slipping off helps in maintaining a sterile field as well as providing a mental comfort to the wearer by knowing that the eye wear is secured in place and the physical comfort to the wearer in distributing the weight evenly and against the back of the head when looking downwardly.

While the eye wear is described in particular reference to a surgical eye wear and light combination, it should be understood that the combination is not limited to surgical eye wear and may include any eye wear and light combination.

It thus is seen that a surgical eve wear and light combination is now provided which overcomes problems associated with the prior art. While this invention has been described in detail with particular references to the preferred embodiments thereof, it should be understood that many modifications additions and deletions, in addition to those expressly recited, may be made thereto without departure from the spirit and scope of the invention as set forth in the following claims.

1. eye wear and light combination comprising,
an eye wear frame having a front portion and a pair of oppositely disposed temple arms extending from said front portion and terminating at distal ends;
a lens coupled to said eye wear frame;
a headband coupled to and extending between said temple arm distal ends;
a light housing including a light source said light housing coupled to said eye wear frame;
a battery pack coupled to said headband, said battery pack including a battery housing and at least one battery, and
an electric conductor extending between said light housing and said battery pack and electrically coupled to said light source and said battery,
whereby the position of battery pack upon the headband causes the battery pack to rest against the back of a wearer's head when the head is tilted forwardly and downwardly.

2. The eye wear and light combination of claim 1 wherein said light housing is pivotally coupled to said eve wear frame front portion.

3. The eye wear and light combination of claim 2 wherein said frame front portion includes a nose bridge portion and wherein said light housing is pivotally coupled to said nose bridge portion.

4. The eye wear and light combination of claim 1 wherein said headband is made of a flexible material.

5. A eye wear and light combination comprising,
an eye wear frame having a front portion with a nose bridge and a pair of oppositely disposed temple arms;
a lens coupled to said eye wear frame;
headband coupled to and extending between said temple
a light source coupled to said eye wear frame;
a battery pack coupled to said headband, said battery pack battery housing and at least one battery, and
an electric conductor electrically coupling said light source with said battery,
whereby the position of battery pack upon the headband causes the battery pack to abut the backside of a wearer's head.

6. The eye wear and light combination of claim 5 wherein said light source is pivotally coupled to said eye wear frame front portion.

7. The eye wear and light combination of claim 6 wherein said light source is pivotally coupled to said nose bridge.

8. The eye wear and light combination of claim 5 wherein said headband is made of a flexible material.
